(19) United States
(12) Patent Application Publication
(10) Pub. No.: US 2020/0159200 A1
(43) Pub. Date: May 21, 2020

(54) MAINTENANCE SUPPORT METHOD AND PROGRAM FOR MAINTENANCE SUPPORT

(71) Applicant: Panasonic Intellectual Property Management Co., Ltd., Osaka (JP)

(72) Inventors: Masakazu HOASHI, Shiga (JP); Hiroshi SUZUKI, Shiga (JP); Hidetomo TAKANISHI, Shiga (JP); Tomoya MINAMI, Shiga (JP)

(21) Appl. No.: 16/735,238

(22) Filed: Jan. 6, 2020

Related U.S. Application Data
(63) Continuation of application No. PCT/JP2018/023797, filed on Jun. 22, 2018.

(30) Foreign Application Priority Data
Jul. 12, 2017 (JP) 2017-136172
Jul. 12, 2017 (JP) 2017-136173

(51) Int. Cl. G05B 23/02; F25C 5/20

(52) U.S. Cl. CPC G05B 23/027; F25C 2400/10; F25C 5/22

(57) ABSTRACT

The following steps are included. Problem information input unit (11) receives an input of problem information about a product. Countermeasure extractor (12) refers to problem dealing data to extract a countermeasure put in correspondence to a problem identified by the problem information. Work procedure output unit (13) refers to work procedure data to submit a work procedure put in correspondence to the countermeasure extracted by countermeasure extractor (12), and outputs work procedure information that explains the extracted work procedure.

### TECHNICAL FIELD

The present disclosure relates to a maintenance support method and a program for maintenance support.

### BACKGROUND ART

Conventionally, there is proposed a method (see PTL 1, for example) as a method for supporting maintenance of products such as home electric appliances. In the method, a web page for after-sales service is set up, for example, and an image of countermeasure for solving a problem (such as breakdown or abnormality) of a product is displayed on a terminal of a user who accesses the web page.

In the method described in PTL 1, the user is asked a plurality of predetermined questions, and a diagnostic image of a problem estimated based on answers from the user is displayed on the user's terminal. If a positive confirmation on this diagnostic image is obtained from the user, an image of countermeasure corresponding to the diagnostic image is displayed on the user's terminal.

In the invention described in above PTL 1, there is sometimes a difference between the problem estimated based on the user's answers and an actually occurring problem. In this case, an image of countermeasure is not obtained, and the user therefore has to contact a seller or a manufacturer of the product and to ask for repair. Then, a maintenance worker visits the user's home to perform maintenance (such as checkup or repair) of the product.

However, if the maintenance worker is unused to handling the target product, the maintenance worker has to refer to a large amount of materials such as a service manual to search for a cause of the problem and a countermeasure to the problem and, in addition, has to understand a work procedure of the countermeasure. Therefore, there is sometimes difficulty in quickly completing the maintenance at a location of the product. In addition, from the large amount of materials such as a service manual, the maintenance worker has to find a place where a description of the work procedure that the maintenance worker wants to know is written. Therefore, working time of the maintenance is sometimes accordingly long.

### CITATION LIST

### Patent Literature

PTL 1: Unexamined Japanese Patent Publication No. 2002-109096

### SUMMARY OF THE INVENTION

The present disclosure has been made in view of such a background and provides a maintenance support device and a program for maintenance support that can support quick maintenance of a product at a location of the product.

Specifically, a method for displaying a procedure of maintenance work for a product on a display according to an example of the present disclosure includes: (i) identifying an error occurred in the product based on an instruction input by a user; (ii) causing the display to display a plurality of countermeasures which correspond to the error identified in the identifying; (iii) when one of the plurality of countermeasures is selected, causing the display to display the procedure which indicates a plurality of processes, the plurality of process corresponding to the selected countermeasure; and (iv) when an instruction to play a movie corresponding to a specific process included in the plurality of processes is received, causing the display to play the movie on the display.

By such a method, In a case where a user (a maintenance worker for a product or another person) of a terminal device who visits a location of a product identifies a problem occurring in the product and inputs problem information in the terminal device, the countermeasure for solving the problem is extracted on the basis of the problem information having been input by a user through a user interface or through a communication network.

Then, the work procedure output step extracts the work procedure put in correspondence to the countermeasure and outputs work explanation information that explains the work procedure. The maintenance worker or the like can refer to the work explanation information thus output, and more quickly perform a work for solving the problem in the right procedure. As described above, the present disclosure can support quick maintenance of a product at a location of the product.

The maintenance support method and the program for maintenance support of the present disclosure enables a maintenance worker who visits a location of a product to recognize a countermeasure for solving a problem occurring in the product and a work procedure of the countermeasure, thereby helping maintenance of the product to be performed quickly at the location of the product.

### BRIEF DESCRIPTION OF DRAWINGS

FIG. 1 is a diagram for describing how maintenance is performed on a product installed in a house in a first exemplary embodiment and a second exemplary embodiment of the present disclosure.

FIG. 2 is a diagram for describing a configuration of a tablet-type terminal device on which the maintenance support method and the program for maintenance support of the present disclosure are performed in the first exemplary embodiment and the second exemplary embodiment of the present disclosure.

FIG. 3 is a diagram for describing data for maintenance stored in a storage of the terminal device in the first exemplary embodiment and the second exemplary embodiment of the present disclosure.

FIG. 4 is a diagram for describing video data that explains a work procedure of a target device for solving a problem of a product in the first exemplary embodiment and the second exemplary embodiment of the present disclosure.

FIG. 5 is a diagram for describing a model top screen in the first exemplary embodiment and the second exemplary embodiment of the present disclosure.

FIG. 6 is a diagram for describing an error code list screen in the first exemplary embodiment and the second exemplary embodiment of the present disclosure.

FIG. 7 is a flowchart of a maintenance support process to be executed on the terminal device in the first exemplary embodiment and the second exemplary embodiment of the present disclosure.

FIG. 8 is a diagram for describing a countermeasure extraction screen in the first exemplary embodiment and the second exemplary embodiment of the present disclosure.

FIG. 9 is a diagram for describing a work procedure screen in the first exemplary embodiment and the second exemplary embodiment of the present disclosure.

FIG. 10 is a diagram for describing a maintenance part specifying screen in the first exemplary embodiment and the second exemplary embodiment of the present disclosure.

FIG. 11 is a diagram for describing a component tree screen in the first exemplary embodiment and the second exemplary embodiment of the present disclosure.

FIG. 12 is a diagram for describing a sub-process list screen where sub-process 1 is selected in the first exemplary embodiment and the second exemplary embodiment of the present disclosure.

FIG. 13 is a diagram for describing the sub-process list screen where sub-process 6 is selected in the first exemplary embodiment and the second exemplary embodiment of the present disclosure.

### DESCRIPTION OF EMBODIMENTS

Hereinafter, examples of exemplary embodiments of the present disclosure will be described with reference to the drawings. Note that the following exemplary embodiments do not limit the present disclosure.

### 1. How Terminal Device is Used

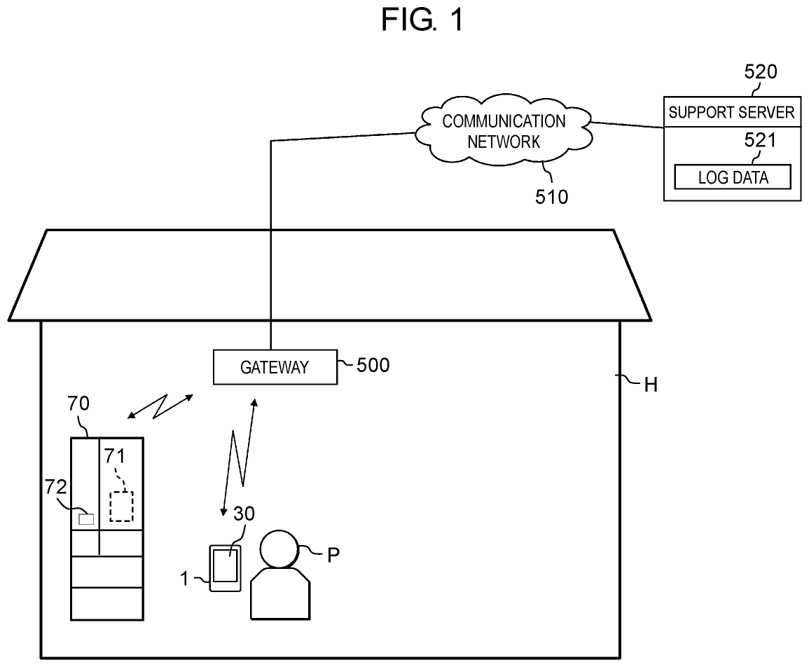

FIG. 1 shows how a terminal device on which a maintenance support method and the program for maintenance support of the present disclosure is used. Terminal device 1 of the first exemplary embodiment of the present disclosure is a tablet-type terminal device including touch panel 30. When maintenance worker P visits house H to perform maintenance (such as checkup, adjustment, or repair) of refrigerator 70 (corresponding to a product of the present disclosure), maintenance worker P uses terminal device 1.

Refrigerator 70 includes: controller 71 that controls an operation of refrigerator 70; and console 72 that is used to set operation conditions of refrigerator 70 and displays error codes to be described later. Controller 71 monitors operating states of actuators (such as a compressor and a motor), and detection signals of sensors (such as a temperature sensor, a humidity sensor, a door open and close sensor, and a current sensor) provided in refrigerator 70.

Controller 71 transmits occasionally or regularly data of the monitored operating states of the actuators and data of the monitored detection signals of the sensors to support server 520 (corresponding to a server of the present disclosure) via gateway 500 (for example, a wireless local area network (LAN) router) installed in house H and communication network 510. Support server 520 stores the received data in a storage device (not shown) as log data 521.

Terminal device 1 can also communicate with support server 520 via gateway 500 and communication network 510 to refer to log data 521. In terminal device 1, there is gathered and stored information about various home electric appliances including refrigerator 70. Maintenance worker P can efficiently perform maintenance of a wide variety of kinds and models of home electric appliances by operating and viewing touch panel 30 of terminal device 1.

Note that in one configuration, all of the information about various home electric appliances may be previously stored in terminal device 1. However, alternatively, in another configuration, all or part of those pieces of information may be stored in a storage device of support server 520, and necessary information may be downloaded from support server 520 into terminal device 1. Such a configuration enables news and the like about home electric appliances to be quickly downloaded from support server 520 or the like and to be provided to maintenance worker P.

### [2. Configuration of Terminal Device]

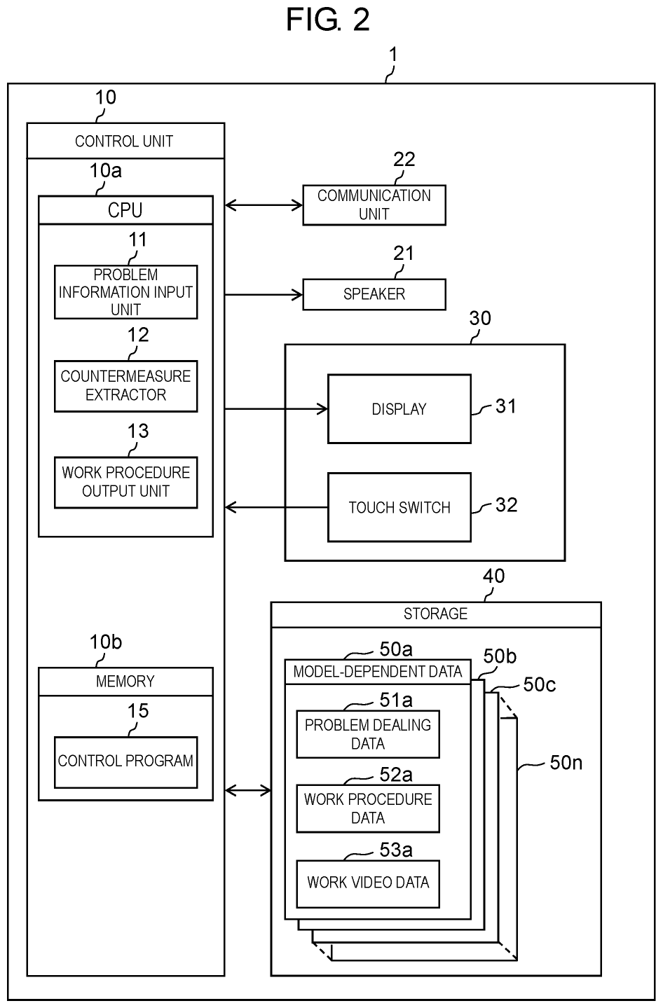

Next, a configuration of terminal device 1 will be described with reference to FIG. 2. Terminal device 1 includes control unit 10, speaker 21, communication unit 22, touch panel 30, and storage 40.

Control unit 10 is an electronic circuit unit that is configured with central processing unit (CPU) 10a, memory 10b, and an interface circuit (not shown), and the like. Control unit 10 functions as problem information input unit 11, countermeasure extractor 12, and work procedure output unit 13 by executing, on CPU 10a, control program 15 (including a program for maintenance support of the present disclosure) for terminal device 1 stored in memory 10b.

Control unit 10 is connected to speaker 21, communication unit 22, touch panel 30, and storage 40. Speaker 21 outputs audio guidance and the like, depending on a voice signal and the like that are output from control unit 10. Communication unit 22 performs transmission, of data, from control unit 10 and reception, of data, to control unit 10 by communicating with support server 520 and the like, depending on a communication control signal that is output from control unit 10.

Touch panel 30 includes: flat panel-type display 31 configured with a liquid crystal panel or the like; and touch switch 32 disposed to cover a surface of display 31. Display 31 displays various screens, depending on an image control signal that is output from control unit 10. Touch switch 32 inputs to control unit 10 an operation signal depending on a touch operation made by a user.

In storage 40, model-dependent data 50a, 50b, . . . , 50n are stored. In each piece of model-dependent data 50a, 50b, . . . , 50n, data for supporting a maintenance work is stored for each model number of home electric appliances. Specifically, there are stored: problem dealing data 51a in which a countermeasure for solving a problem that can occur in a product is put in correspondence to the problem; work procedure data 52a in which an execution procedure of the countermeasure is put in correspondence to the countermeasure; and work video data 53a in which a work procedure of the countermeasure is explained with a video image. Because model-dependent data 50a, 50b, . . . , 50n have the same configuration, a description will be given hereinafter while collectively referring to those reference marks as model-dependent data 50, problem dealing data 51 (51a, 51b to 51n), work procedure data 52 (52a, 52b to 52n), and work video data 53 (53a, 53b to 53n).

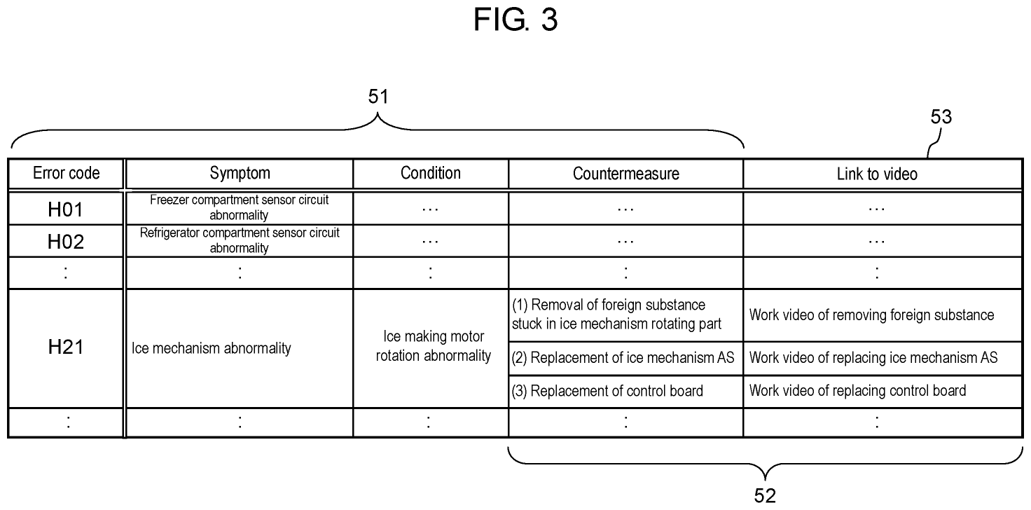

Next, problem dealing data 51 and work procedure data 52 will be described with reference to FIG. 3. First, problem dealing data 51 are configured such that symptoms, detected conditions, and countermeasures are put in correspondence to error codes H01, H02, . . . (corresponding to identification information individually assigned to each of a plurality of problems of the present disclosure) that are each assigned to each of the problem that can occur in refrigerator 70.

FIG. 3 exemplifies a case where the symptom “Ice mechanism abnormality”, the detected condition “Ice making motor rotation abnormality”, and the countermeasures “(1) Removal of foreign substance stuck in ice mechanism rotating part, (2) Replacement of ice mechanism, and (3) Replacement of control board” are put in correspondence to error code H21.

Further, work procedure data 52 is configured such that, to each countermeasure, a linked destination of a video image (work video) that explains the work procedure of each countermeasure is put in correspondence. As shown in FIG. 2, if work video data 53 is stored in storage 40, the linked destination is an address of a storage location of work video data for each countermeasure contained in work video data 53. Further, if the work video data is stored in a storage device of support server 520, the linked destination is an address of a storage location of work video data for each countermeasure in support server 520.

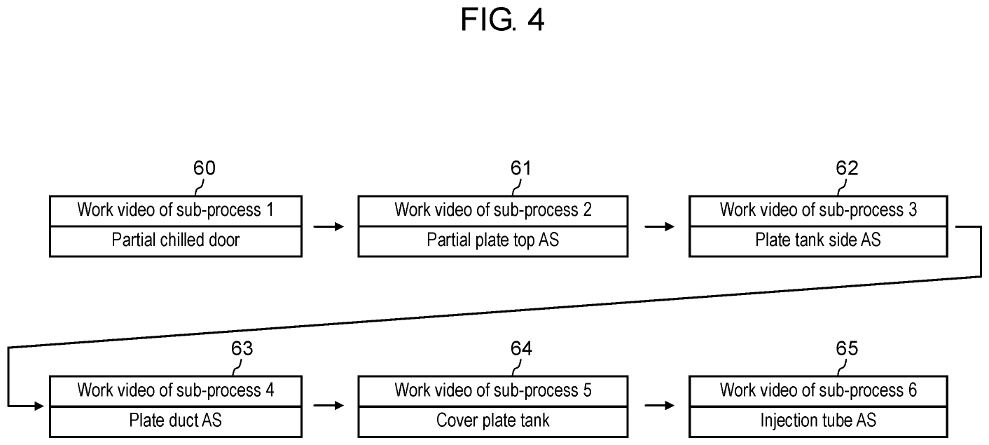

Here, as shown in FIG. 4, if a countermeasure for solving a problem is divided into a plurality of sub-processes (FIG. 4 illustrates sub-process 1 to sub-process 6), the work video data is stored being divided into individual sub-processes. In the example of FIG. 4, a disassembly work made up of the following six sub-processes is required to replace injection tube AS: sub-process 1 of “Partial chilled door; sub-process 2 of “Partial plate top”; sub-process 3 of “Plate tank side AS”, sub-process 4 of “Plate duct AS”, sub-process 5 of “Cover plate tank”; and sub-process 6 of “Injection tube AS”.

For each of sub-process 1 to sub-process 6, each of work video data 60 to 65 explaining the work procedure of each sub-process is individually stored. With this arrangement, it is possible to reproduce a work video for each sub-process. Note that the work video data may be configured, for example, such that an index indicating each reproduction part of each sub-process is attached to work video data of the entire process of a countermeasure so that the work video data of each sub-process is reproduced.

### 3. Maintenance Support Process

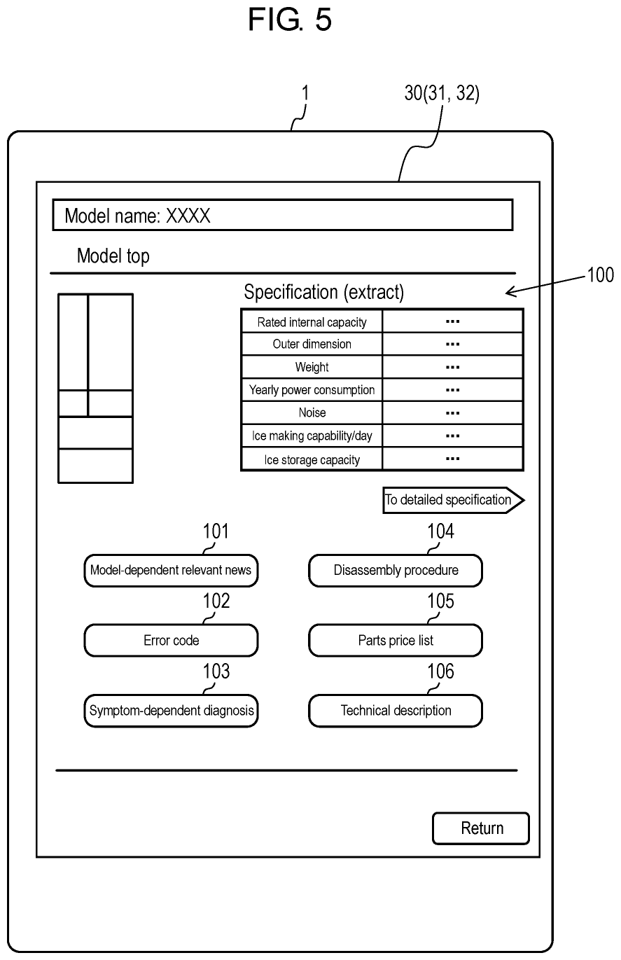

Next, a maintenance support process to be executed on terminal device 1 will be described. Control unit 10 of terminal device 1 displays a model selection screen on display 31 when a maintenance worker starts up an application for maintenance support. When the maintenance worker operates touch switch 32 to input a model name of a product, control unit 10 displays, in response to this input, model top screen 100 as shown in FIG. 5 on display 31.

Note that a description will be given hereinafter in a case where a model name of refrigerator 70 is input, but the maintenance worker can input a model name of a home electric appliance (such as a television, an air conditioner, or a washing machine) other than a refrigerator. Further, control unit 10 may display, on display 31, a model top screen for the model name of a home electric appliance having been input. This arrangement enables the maintenance worker to deal with maintenance of not only refrigerators but also other home electric appliances.

On model top screen 100 as shown in FIG. 5, to select a menu corresponding to the selected model name (the model name of refrigerator 70, in this case), control unit 10 displays model-dependent relevant news button 101, error code button 102, symptom-dependent diagnosis button 103, disassembly procedure button 104, parts price list display button 105, and technical description button 106. In response to a selection operation of the maintenance worker on buttons 101 to 106, control unit 10 switches the screen display on display 31 to a content corresponding to the selection.

For example, if model-dependent relevant news button 101 is operated and selected, control unit 10 downloads information such as quality relevant news linked to the model name from support server 520 and displays the information on display 31.

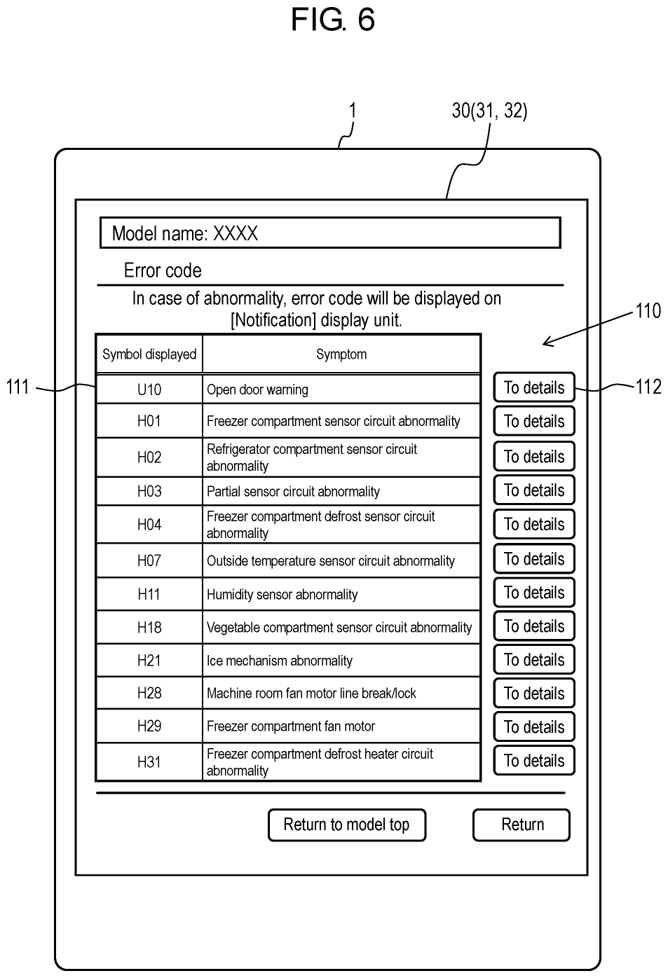

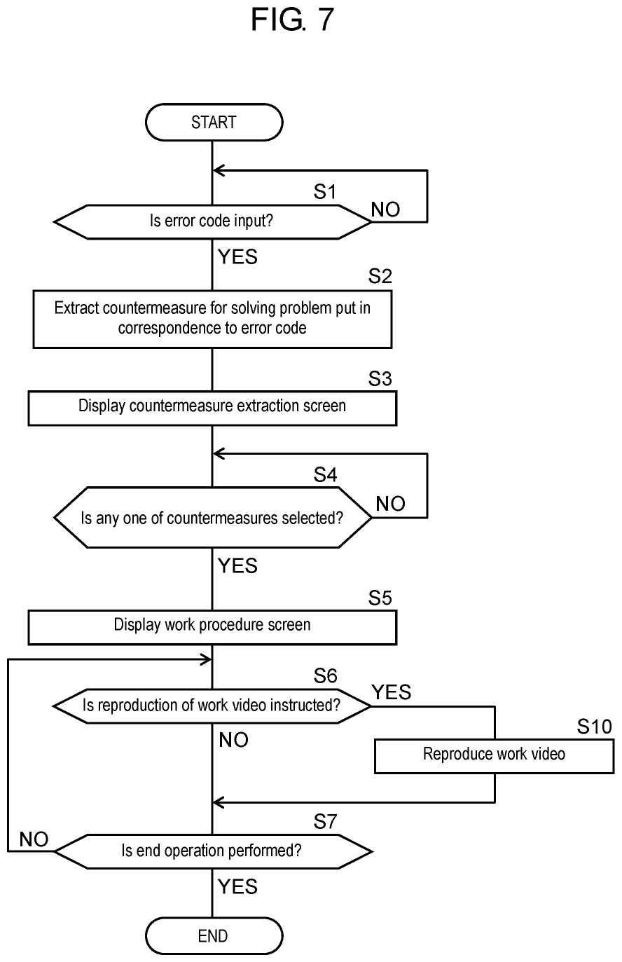

If the maintenance worker performs a selection operation on error code button 102 on model top screen 100 as shown in FIG. 5, control unit 10 displays error code list screen 110 as shown in FIG. 6 on display 31 and performs a process according to a flowchart as shown in FIG. 7. Control program 15 stored in memory 10b of control unit 10 includes the program for maintenance support of the present disclosure, and by this program for maintenance support being executed on CPU 10a, the process according to the flowchart of FIG. 7 is performed. Further, by processes in the steps of the flowchart of FIG. 7, the maintenance support method of the present disclosure is performed. Hereinafter, the maintenance support process according to the flowchart of FIG. 7 will be described.

Step S1 of FIG. 7 is a process to be performed by problem information input unit 11, and the process in step S1 corresponds to a problem information input step of the present disclosure. Problem information input unit 11 displays on display 31 error code list screen 110 shown in FIG. 6. On error code list screen 110 there are displayed error code list 111 that shows the error codes and the corresponding symptoms, and selection buttons 112 to select an error code. Problem information input unit 11 causes the process to proceed to step S2 if any selection button 112 is operated.

Steps S2 to S4 are processes to be performed by countermeasure extractor 12. The processes in steps S2 to S4 correspond to a countermeasure extraction step of the present disclosure. In step S2, countermeasure extractor 12 refers to problem dealing data 51 in model-dependent data 50 corresponding to the error code selected in step S1 and extracts the countermeasure put in correspondence to the error code.

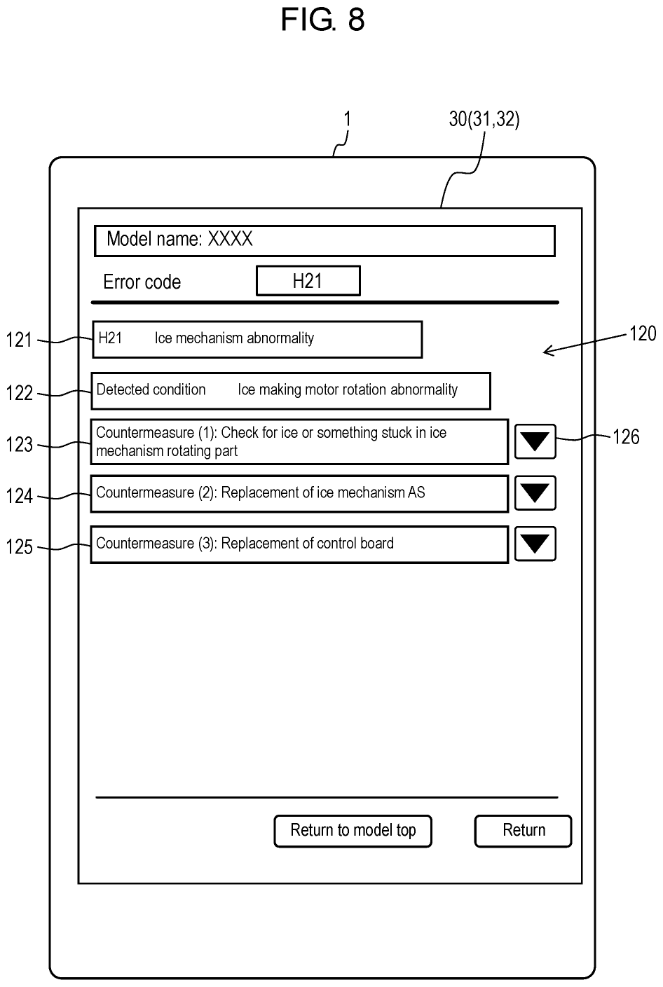

In subsequent step S3, countermeasure extractor 12 displays, on display 31, countermeasure extraction screen 120 shown in FIG. 8. FIG. 8 exemplifies a case where the error code “H21” is selected. Countermeasure extractor 12 displays: symptom (“Ice mechanism abnormality”, in this case) 121 corresponding to the error code; detected condition of the error (“Ice making motor rotation abnormality”, in this case) 122; three extracted countermeasures 123 to 125; and selection buttons 126 for selection of a countermeasure. In subsequent step S4, countermeasure extractor 12 causes the process to proceed to step S5, when any one of the countermeasures is selected (where the selection corresponds to a third selection of the present disclosure).

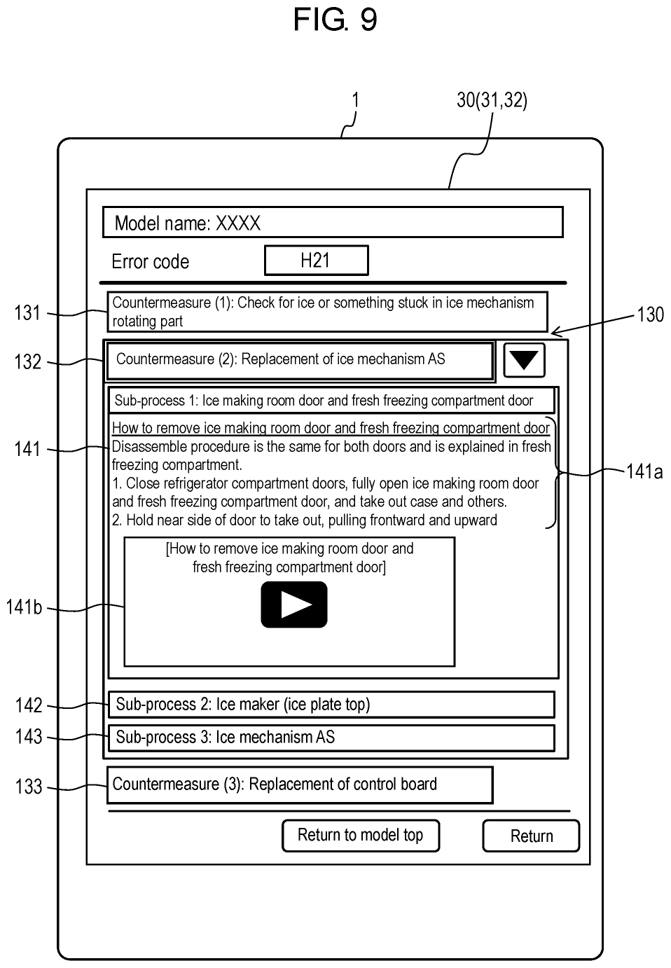

Steps S5 to S6 and S10 are processes to be performed by work procedure output unit 13. Steps S5 to S6 and S10 correspond to a work procedure output step of the present disclosure. In step S5, work procedure output unit 13 displays, on display 31, work procedure screen 130 as shown in FIG. 9.

FIG. 9 shows as example work procedure screen 130 in a case where “Countermeasure (2): Replacement of ice mechanism AS” of three countermeasures is selected. Work procedure output unit 13 enlarges display area 132 for selected countermeasure (2) of display areas 131 to 133 for countermeasures (1) to (3), and displays the work procedure of countermeasure (2).

The countermeasure “Countermeasure (2): Replacement of ice mechanism AS” includes three sub-processes of “Sub-process 1: Ice making room door and fresh freezing compartment door”; “Sub-process 2: Ice maker (ice plate top)”; and “Sub-process 3: Ice mechanism AS”. Work procedure output unit 13 displays display areas 141 to 143 for the three sub-processes.

The maintenance worker can select any one of display areas 141 to 143 for the three sub-processes (where the selection corresponds to a fourth selection of the present disclosure). Depending on this selection, work procedure output unit 13 enlarges the selected display area and displays work procedure information in the display area.

FIG. 9 shows the case where “Sub-process 1: Ice making room door and fresh freezing compartment door” is selected. Work procedure output unit 13 has enlarged display area 141 for sub-process 1 and is displaying explanatory text 141a and video area 141b of the work procedure of sub-process 1.

If the maintenance worker gives an instruction to reproduce the work video (a touch operation in video area 141b) in step S6, work procedure output unit 13 refers to work video data 53 to obtain the work video data of sub-process 1, reproduces the work video, and then causes the process to proceed to step S7. By viewing explanatory text 141a and the work video, the maintenance worker can easily understand the work procedure and can quickly perform the working of maintenance.

In addition, regarding the work procedure of the countermeasure, the maintenance worker can selectively view an explanatory text and a work video for each sub-process. Therefore, by this arrangement, the maintenance worker can obtain the information of the work procedure more efficiently and perform a maintenance work more quickly than in a case of collectively viewing all explanatory texts and all work videos of the countermeasure.

On the other hand, if there is no instruction to reproduce the work video in step S6, work procedure output unit 13 causes the process to proceed to step S7. If an end operation (such as an operation of “Return to model top”) is performed in step S7, the process according to the flowchart of FIG. 7 is finished, and if there is no end operation performed, the process goes back to step S6.

### 4. Other Exemplary Embodiments Related to Input of Problem Information

In the example described in the above present exemplary embodiment, an error code is input as problem information; however, a name of a problem (for example, “ice mechanism abnormality”) may be input. In this case, countermeasure extractor 12 extracts a countermeasure for solving the problem by referring to problem dealing data in which countermeasures are put in correspondence to previously prepared names of problems.

Further, log data stored in support server 520 may be input as the problem information. In this case, countermeasure extractor 12 identifies the problem occurring in the product, based on operating conditions and history of detected statuses of the sensors contained in the log data. Countermeasure extractor 12 extracts a countermeasure for solving the problem by referring to problem dealing data in which countermeasures are put in correspondence to previously prepared problems.

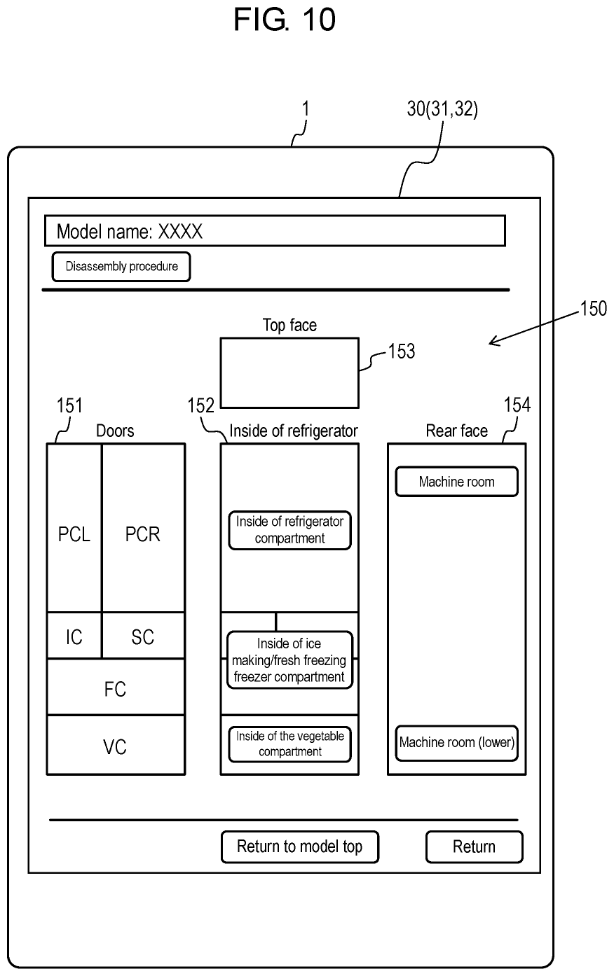

Further, a part to be maintained may be input as problem information. In this case, on model top screen 100 as shown in FIG. 6, the maintenance worker performs a selection operation on disassembly procedure button 104. Depending on this selection operation, problem information input unit 11 displays on display 31 maintenance part specifying screen 150 as shown in FIG. 10.

Maintenance part specifying screen 150 includes door layout drawing 151 showing a layout of doors of refrigerator 70, refrigerator interior layout drawing 152 showing a layout in refrigerator 70, top face drawing 153 of a top face of refrigerator 70, and machine room layout drawing 154 showing a layout of machine rooms of refrigerator 70.

Regarding door layout drawing 151, the maintenance worker can select any one of refrigerator compartment left door PCL, refrigerator compartment right door PCR, ice making room door IC, fresh freezing compartment door SC, freezer compartment door FC, and vegetable compartment door VC, for example, by a touch operation. Further, regarding refrigerator interior layout drawing 152, the maintenance worker can select any one part of an inside of the refrigerator compartment, an inside of an ice making room, an inside of a fresh freezing compartment, an inside of a freezer compartment, and an inside of the vegetable compartment, by a touch operation, for example.

Further, regarding top face drawing 153, the maintenance worker can select the top face by a touch operation, for example. Further, regarding machine room layout drawing 154, the maintenance worker can select at least one of the machine room and the machine room (lower) by a touch operation, for example.

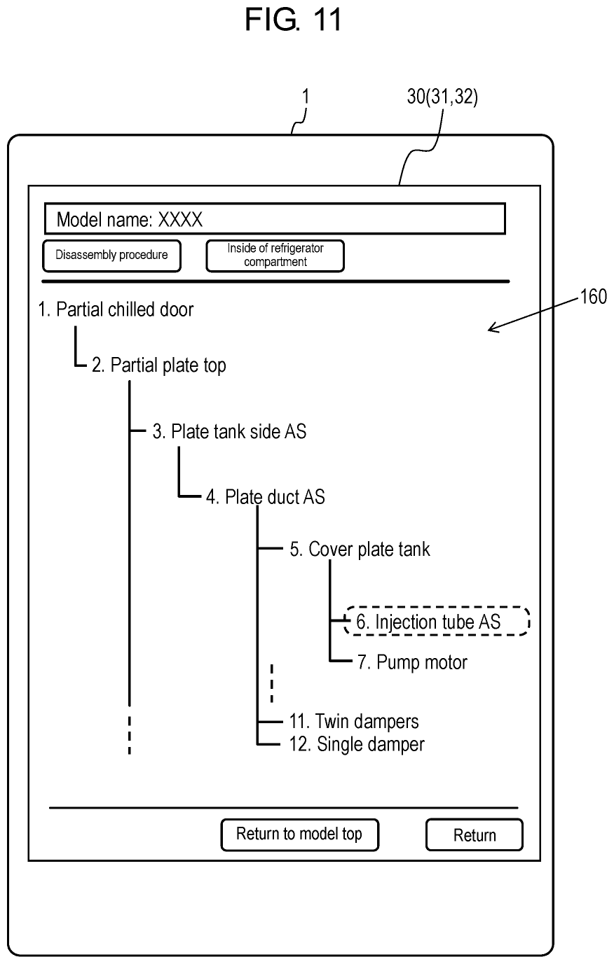

When maintenance worker selects any one part of door layout drawing 151, refrigerator interior layout drawing 152, top face drawing 153, and machine room layout drawing 154 by a touch operation or the like (where the selection corresponds to a first operation of the present disclosure), problem information input unit 11 displays component tree screen 160 in which the components disposed in the selected part are displayed in a tree form following a disassembly process, on display 31 as shown in FIG. 11.

FIG. 11 exemplifies a case where the maintenance worker has selected the inside of the refrigerator compartment on refrigerator interior layout drawing 152. FIG. 11 shows the constituent components in the tree form following the steps of the disassembly process in such a manner that “1. Partial chilled door” is a point of origin and is followed by “2. Partial plate top”, “3. Plate duct AS”, . . . .

The maintenance worker can select a component to be maintained from the components displayed on component tree screen 160 by a touch operation (where the selection corresponds to a second operation of the present disclosure). FIG. 11 shows a state where “6. Injection tube AS” is selected. Depending on this selection, problem information input unit 11 inputs the breakdown of the injection tube AS as the problem information.

In response to the input of the problem information indicating that the injection tube AS is broken down, countermeasure extractor 12 refers to the problem dealing data in which countermeasures are put in correspondence to previously prepared problems. Countermeasure extractor 12 extracts replacement of injection tube AS as the countermeasure.

On the basis of the configuration of the components shown in component tree screen 160 as shown in FIG. 11, work procedure output unit 13 extracts “1. Partial chilled door”, “2. Partial plate top”, “3. Plate tank side AS”, “4. Plate duct AS”, “5. Cover plate tank”, and “6. Injection tube AS” as the sub-processes included in the replacement work of the injection tube AS.

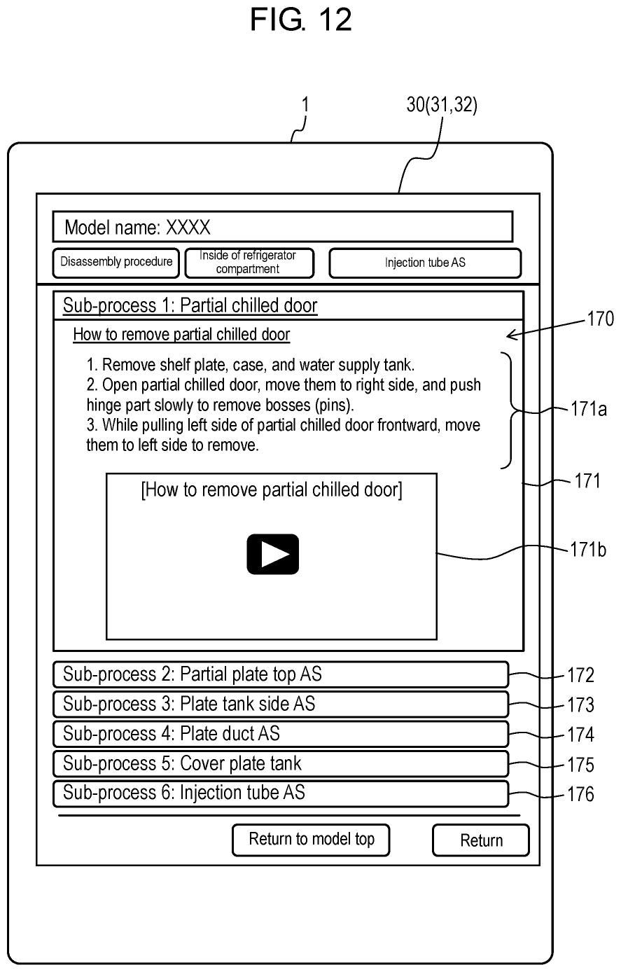

As shown in FIG. 12, work procedure output unit 13 displays sub-process list screen 170 showing a list of the extracted sub-processes, on display 31. Sub-process list screen 170 displays display areas 171 to 176 for sub-processes 1 to 6.

The maintenance worker can select a sub-process that displays a work procedure, by performing a touch operation or the like on any one of display areas 171 to 176 for sub-processes 1 to 6.

FIG. 12 exemplifies a state where sub-process 1 is selected. Work procedure output unit 13 refers to work procedure data 52 to obtain the data of the work procedure (the explanatory text of the work procedure and the data of the work video) put in correspondence to sub-process 1.

Work procedure output unit 13 enlarges display area 171 for sub-process 1 to display explanatory text 171a of the work procedure of sub-process 1 (partial chilled door) and video area 171b. Work procedure output unit 13 reproduces the work video of sub-process 1, in response to the operation such as a touch operation on video area 171b performed by the maintenance worker.

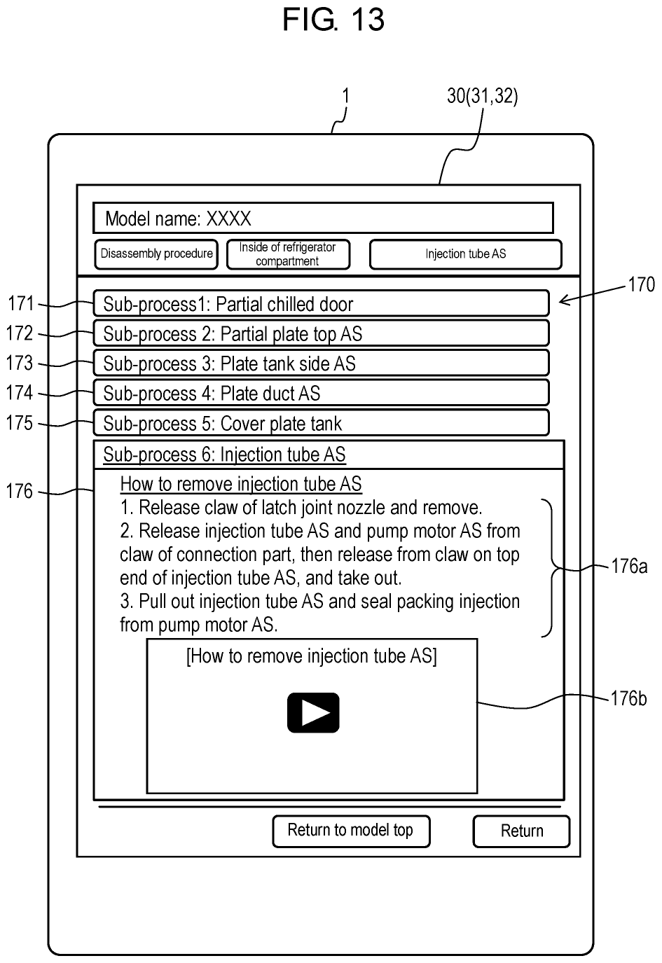

FIG. 13 exemplifies a state where sub-process 6 (injection tube AS) is selected. With reference to FIG. 13, work procedure output unit 13 enlarges display area 176 for sub-process 6 to display explanatory text 176a of the work procedure of sub-process 6 and video area 176b. Work procedure output unit 13 reproduces the work video of sub-process 6, in response to a touch operation on video area 176b performed by the maintenance worker.

As described above, when the countermeasure is divided into some sub-processes, the maintenance worker can view an explanatory text and an explanatory video by selecting the sub-process about which the maintenance worker wants to know a work procedure. Therefore, by such a method, the maintenance worker can more efficiently view only the work procedure of the sub-process the maintenance worker wants to know and can more quickly perform a maintenance work than in a case where the entire work procedures of a countermeasure are collectively output in the forms of an explanatory text and an explanatory video.

### 5. Other Exemplary Embodiments

In the above exemplary embodiments, a refrigerator is described as the product of the present disclosure; however, the product of the present disclosure can be applied to various products such as home electric appliances other than refrigerators, vehicles, manufacturing equipment, and the like.

In the above exemplary embodiments, as shown in FIG. 1, terminal device 1 is configured to recognize the operating statuses of the actuators measured in refrigerator 70 and the detected statuses of the sensors by referring to log data 521 stored in the storage device of support server 520. Terminal device 1 is not limited to such a configuration and may be configured to recognize the operating states of the actuators and the detected statuses of the sensors by directly communicating with controller 71 of refrigerator 70.

In the above exemplary embodiments, an example is described in which a process is performed such that the explanatory text and the work video of the work procedure of the countermeasure are displayed on display 31 as the output of the work procedure information; however, a process may be performed to output audio guidance explaining the work procedure from speaker 21.

In the above exemplary embodiments, tablet-type terminal device 1 is described as the terminal device of the present disclosure; however, the terminal device is not limited to tablet-type terminal device 1; and a laptop personal computer (PC), a smartphone, or the like may be used as the terminal device of the present disclosure.

As described above, the maintenance support method according to an example of the present disclosure is a maintenance support method to be performed by, for example, a terminal device. A maintenance support method according to an example of the present disclosure includes: (i) a problem information input step of inputting problem information about a product; and (ii) a countermeasure extraction step of: referring to problem dealing data in which, to each of a plurality of problems that can occur in the product, a countermeasure for solving each problem is put in correspondence; and extracting a countermeasure put in correspondence to the problem identified by the problem information. In addition, the maintenance support method according to an example of the present disclosure includes a work procedure output step of: (i) referring to work procedure data in which, to each of a plurality of countermeasures contained in the problem dealing data, a work procedure for performing each countermeasure is put in correspondence; (ii) extracting a work procedure put in correspondence to the countermeasure extracted in the countermeasure extraction step; and (iii) outputting work procedure information that describes the extracted work procedure.

By such a method, when problem information about a product is input in the problem information input step by a user of the terminal device (by a maintenance worker for the product or another person), the countermeasure extraction step extracts the countermeasure to the problem. Then, the work procedure output step extracts the work procedure put in correspondence to the countermeasure and outputs work explanation information that explains the work procedure. The maintenance worker or the like can easily understand the work procedure of the countermeasure for solving the problem of the product by recognizing the work explanation information. Therefore, such a method can support quick performance of maintenance of the product at a location of the product.

Further, in the maintenance support method according to an example of the present disclosure, in the problem information input step, it is possible to input, as problem information, identification information individually assigned to each of a plurality of problems that can occur in the product.

By such a method, the user of the terminal device can obtain the work explanation information of the countermeasure for solving the problem, by inputting, as the problem information, (i) the error code that is output from the product when a problem occurs or (ii) identification information individually assigned to each problem such as a name of a typical problem of the product.

Further, in the maintenance support method according to an example of the present disclosure, in the problem information input step, measurement data about the operation of the product measured in the product may be input as the problem information.

By such a method, the user of the terminal device can obtain the working explanation information of the countermeasure for solving the problem by inputting the measurement data about the operation of the product as the problem information.

Further, in the maintenance support method according to an example of the present disclosure, the problem information input step may include a target component determination step that include: (i) displaying, on a display or the like, a product configuration diagram showing a plurality of constituent parts constituting the product; (ii) displaying, depending on a first selection operation of any one of the constituent parts performed on the product configuration diagram, a disassembled configuration diagram on which a selected constituent part is disassembled in stages, on the display or the like; and (iii) determining a component to be maintained depending on a second selection operation performed on the disassembled configuration diagram by a user. In this case, in the maintenance support method according to an example of the present disclosure, the name of the component determined in the target component determination step may be input as the problem information.

By such a method, the maintenance worker or the like can obtain operation explanation information for solving the problem by determining the component to be maintained by using the product configuration diagram and the disassembled configuration diagram and by using the target component determination step.

Further, in the maintenance support method according to an example of the present disclosure, if a plurality of countermeasures are extracted in the countermeasure extraction step, any one of the plurality of countermeasures may be selected in the work procedure output step depending on a third selection operation so that the work procedure put in correspondence to the selected countermeasure is extracted.

By such a method, when a plurality of countermeasures are selected, the maintenance worker or the like can select any one of the countermeasures and obtain the work explanation information of the selected countermeasure.

Further, in the maintenance support method according to an example of the present disclosure, in the countermeasure extraction step, it is also possible to communicate with a first server via, for example, a network to refer to the problem dealing data stored in the first server.

By such a method, it is possible to obtain the problem dealing data about the product in which the problem is occurring, by communicating with the first server. Therefore, by such a method, it is possible to achieve maintenance support that can deal with a large variety of types and other models of products without having a large capacity storage in the terminal device.

Further, in the maintenance support method according to an example of the present disclosure, it is also possible to communicate with a second server via, for example, a network to refer to the work procedure data stored in the second server in the work procedure output step.

By such a method, it is possible to obtain the work procedure data about the product in which the problem is occurring, by communicating with the second server. Therefore, by such a method, it is possible to achieve maintenance support that can deal with a large variety of types and other models of products without having a large capacity storage in the terminal device.

Further, in the maintenance support method according to an example of the present disclosure, if the work procedure extracted in the work procedure output step includes a plurality of sub-processes, it is possible to output the work procedure information of the sub-process selected by a fourth selection operation.

By such a method, when the work procedure of a countermeasure includes a plurality of sub-processes, the maintenance worker or the like can select, by a fourth selection operation, only the work explanation information of the sub-process that the maintenance worker or the like determines needs to be checked. As described above, by outputting the work explanation information of only the necessary sub-process, it is possible to make time required to perform maintenance shorter than in the case where the work explanation information of all the sub-processes is collectively output.

Further, in the maintenance support method according to an example of the present disclosure, a countermeasure may include replacement of a predetermined component. In this case, in the maintenance support method according to an example of the present disclosure, a work procedure put in correspondence to the countermeasure in the work procedure data may include, as a plurality of sub-processes, disassembly works over a plurality of stages required to replace the predetermined component.

By such a method, it is possible to efficiently provide work explanation information of only a part required to be disassembled to a user of the terminal device who knows the work procedure to a certain extent.

Further, in the maintenance support method according to an example of the present disclosure, the work explanation information may be a video image to explain a work content of a sub-process.

By such a method, it is possible to help the maintenance worker for the product to easily understand the work procedure of each sub-process by using the video image.

Further, the program for maintenance support according to an example of the present disclosure is a program for maintenance support to be executed on, for example, a terminal device. The program for maintenance support according to an example of the present disclosure causes, for example, the terminal device to function as a problem information input unit, a countermeasure extractor, and a work procedure output unit. The problem information input unit inputs problem information about the product. The countermeasure extractor refers to problem dealing data in which, to each of a plurality of problems that can occur in the product, a countermeasure for solving each of the plurality of problems is put in correspondence, and the countermeasure extractor extracts a countermeasure put in correspondence to a problem identified by the problem information. The work procedure output unit (i) refers to work procedure data to which a work procedure for performing each of a plurality of countermeasures contained in the problem dealing data is put in correspondence, (ii) extracts a work procedure put in correspondence to the countermeasure extracted by the countermeasure extractor, and (iii) outputs work procedure information that describes the extracted work procedure.

If such a program is executed on, for example, a terminal device to cause the terminal device to function as the problem information input unit, the countermeasure extractor, and the work procedure output unit, the countermeasure for solving the problem occurring in the product and the work procedure of the countermeasure are extracted in the same manner as in the above-mentioned maintenance support method, and work explanation information that explains the work procedure is output. This enables a user of the terminal device (a maintenance worker or the like) to recognize a work explanation procedure and to easily understand the work procedure. Therefore, such a program can support quick maintenance of the product at a location of the product.

Further, the maintenance support method according to an example of the present disclosure may include a work procedure output step including: (i) referring, depending on a first selection operation, to work procedure data in which, to a plurality of countermeasures for solving problems that can occur in a product, work procedures for performing the corresponding countermeasures are put in correspondence; (ii) extracting a work procedure put in correspondence to a countermeasure selected by the first selection operation; (iii) if the extracted work procedure includes a plurality of sub-processes, selecting any one of the sub-processes, depending on a second selection operation; and (iv) outputting work procedure information that explains a work procedure of the selected sub-process.

By such a method, when a user of the terminal device (a maintenance worker for the product or another person) performs the first selection operation to select the countermeasure for solving the problem occurring in the product, the work procedure output step extracts the work procedure of the selected countermeasure. If the selected work procedure includes a plurality of sub-processes, any one of the sub-processes is selected depending on the second selection operation performed by the user, and the work procedure information of the selected sub-process is output. In this way, of the work procedures of the countermeasure, the user can select only the work procedure information of the sub-process that the user wants to know, and the user can output the selected work procedure information. Therefore, by such a method, it is possible to more quickly present explanation of the work procedure that the maintenance worker or the like wants to know than in the case where the work procedure information of all the countermeasures is collectively output.

Further, in the maintenance support method according to an example of the present disclosure, a countermeasure may include replacement of a predetermined component. In this case, the work procedure put in correspondence to the countermeasure in the work procedure data may include, as a plurality of sub-processes, disassembly works over a plurality of stages required to replace the predetermined component.

By such a method, it is possible to efficiently provide work procedure information of only a part required to be disassembled to the maintenance worker or another person who knows the work procedure to a certain extent.

Further, in the maintenance support method according to an example of the present disclosure, the work procedure information may be a video image to explain a work content of a sub-process.

By such a method, it is possible to help the maintenance worker to easily understand the work procedure of each sub-process by using the video image.

Further, in the maintenance support method according to an example of the present disclosure, it is also possible to communicate with a server via, for example, a network to refer to the work procedure data stored in the server in the work procedure output step.

By such a method, it is possible to obtain the work procedure data about the product in which the problem is occurring, by communicating with the server. Therefore, it is possible to achieve maintenance support that can deal with a large variety of types and other models of products without having a large capacity storage in the terminal device.

Further, the program for maintenance support according to an example of the present disclosure is executed on, for example, a terminal device. Specifically, the program for maintenance support according to an example of the present disclosure may be configured to cause a terminal device to function as a work procedure output unit that (i) refers, depending on a first selection operation, to work procedure data in which, to a plurality of countermeasures for solving problems that can occur in a product, work procedures for performing the corresponding countermeasures are put in correspondence, (ii) extracts a work procedure put in correspondence to a countermeasure selected by the first selection operation, (iii) if the extracted work procedure includes a plurality of sub-processes, selects any one of the sub-processes depending on a second selection operation, and (iv) outputs work procedure information that explains a work procedure of the selected sub-process.

Such a program for maintenance support is executed on, for example, a terminal device to cause the terminal device to function as the work procedure output unit, so that, in the same manner as in the above-mentioned maintenance support method, it is possible to select, of the work procedures of the countermeasure for solving the problem occurring in the product, the work procedure information of only the sub-process required to be checked and to then output the selected work procedure information. Therefore, by such a program, it is possible to more quickly present explanation of the work procedure that a user of the terminal device (the maintenance worker for the product or another person) wants to know than in the case where the work procedure information of all the countermeasures is collectively output.

### INDUSTRIAL APPLICABILITY

As described above, the present disclosure provides a maintenance support method and a program for maintenance support that can provide a maintenance worker visiting a location of a product with a countermeasure for solving a problem occurring in the product and with information of a work procedure of the countermeasure. Therefore, the present disclosure can be applied for support of quick maintenance of various products.

### REFERENCE MARKS IN THE DRAWINGS

1 terminal device

10 control unit

10a CPU

10b memory

11 problem information input unit

12 countermeasure extractor

13 work procedure output unit

15 control program

21 speaker

22 communication unit

30 touch panel

31 display

32 touch switch

40 storage

50, 50a, 50b to 50n model-dependent data

51, 51a, 51b to 51n problem dealing data

52, 52a, 52b to 52n work procedure data

53, 53a, 53b to 53n work video data

70 refrigerator

71 controller

72 console

100 model top screen

101 model-dependent relevant news button

102 error code button

103 symptom-dependent diagnosis button

104 disassembly procedure button

105 parts price list display button

106 technical description button

110 error code list screen

112 selection button

120 countermeasure extraction screen

123 to 125 countermeasure

126 selection button

130 work procedure screen

131 to 133 display area

141 to 143 display area

141a explanatory text

141b video area

150 maintenance part specifying screen

152 refrigerator interior layout drawing

153 top face view

154 machine room layout drawing

160 component tree screen

170 sub-process list screen

171a explanatory text

171b video area

171 to 176 display area

176a explanatory text

176b video area

500 gateway

510 communication network

520 support server

521 log data

P maintenance worker (user)

H house (location of product)

H01, H02 to Hn error code

1. A method for displaying a procedure of maintenance work for a product on a display comprising:
identifying an error occurred in the product based on an instruction input by a user;
causing the display to display a plurality of countermeasures which correspond to the error identified in the identifying;
when one of the plurality of countermeasures is selected, causing the display to display the procedure which indicates a plurality of processes, the plurality of process corresponding to the selected countermeasure; and
when an instruction to play a movie corresponding to a specific process included in the plurality of processes is received, causing the display to play the movie on the display.

2. The method according to claim 1, wherein the product is a refrigerator.

3. The method according to claim 2, wherein the error includes an abnormality of an ice mechanism of the refrigerator, and the plurality of countermeasures include a removal of foreign substance stuck in the ice mechanism and a replacement of the ice mechanism.

4. The method according to claim 1, wherein when one of the plurality of process is selected, (i) an explanation of the one of the plurality of process and (ii) an object for receiving, an input of the instruction to play the movie corresponding to the one of the plurality of process are displayed on the display.

5. The method according to claim 1, further comprising:
obtaining data for playing the movie on the display from a server which is configured to communicate, directly or indirectly, with the display, when the input of the instruction to play the movie is received via the display,
wherein the movie is played on the display using the data received in the obtaining.

6. The method according to claim 1, wherein the error occurred in the product is identified based on an error code input by the user.
